(19) United States
(12) Patent Application Publication
(10) Pub. No.: US 2017/0296423 A1
(43) Pub. Date: Oct. 19, 2017

(54) PIEZOELECTRIC PRESSURE CUFF

(71) Applicant: Timothy Smith, Elgin, IL (US)

(72) Inventor: Timothy Smith, Elgin, IL (US)

(21) Appl. No.: 15/133,051

(22) Filed: Apr. 19, 2016

(51) Int. Cl. A61H 9/00

(52) U.S. Cl. CPC A61H 9/0092; A61H 9/0007; A61H 2201/1207; A61H 2201/5071; A61H 2201/1654

(57) ABSTRACT

A pressure cuff is provided, comprising a plurality of layers and a controller. The layers comprise: an outer covering, an outer surface of which is exposed when the pressure cuff is secured around a body part of a patient; a first conductive layer; a first insulating layer separating the outer covering and the first conductive layer; an inner covering, the inner surface of which contacts the patient or the patient's clothing when the pressure cuff is secured to the patient; a second conductive layer; a second insulating layer separating the inner covering and the second conductive layer; and a first piezoelectric support layer separating the first and second conductive layers. The controller is electrically coupled to the first and second conductive layers and configured to supply a voltage to the first and second conductive layers, whereupon the first piezoelectric support layer constricts around the body part of the patient.

### TECHNICAL FIELD

The present invention relates to pressure cuffs for the treatment of edema and like disorders.

### BACKGROUND ART

The lymphatic system includes lymph vessels, lymph nodes, and lymphoid tissues. Lymphatic fluid, or lymph, is collected from the interstitial spaces and is composed of fluids, organic and inorganic materials, and proteins too large for the venous system. In contrast to the closed-loop blood circulatory system, the lymphatic system works generally on a one-way flow principal. The lymph is first collected at the lymph capillaries that, in turn, drain into larger vessels. The movement of the collected lymph is generally from the more distal portions of the body inwardly toward the various lymph nodes and lymphoid tissues. The motive force for the lymph flow is generally associated with contractions of the adjacent muscles and walls of the larger vessels. Foreign matter and bacteria are filtered at various lymph nodes, after which the fluid enters into the venous system.

Edema is defined as the accumulation of excess fluid in interstitial tissues, which is generally apparent as swelling of the affected area. This fluid accumulation can occur in the cells (cellular edema), in intercellular spaces within tissues (interstitial edema), or in potential spaces or cavities within the body. Edema can be caused by a variety of factors, including conditions that affect osmotic pressure, such as hypotonic fluid overload, which allows the movement of water into the intracellular space, or hypoproteinemia, which decreases the concentration of proteins and permits the passage of fluid out of the blood vessels into the tissue spaces. Edema also commonly results from surgery, injury, and other trauma or stress to the body. Vigorous exercise, for example, engaging in competitive sports, can produce stressors in the body, and particularly, in the joints, which result in edema or localized swelling.

Other causes of edema include poor lymphatic drainage (lymphedema); conditions that cause increased capillary pressure, such as excessive retention of salt and water; heart failure; and conditions that increase capillary permeability, such as inflammation. The swelling associated with edema can, in turn, cause pain and impede wound healing. If left untreated, fibrosis (a hardening of the tissue) may further complicate the drainage process.

Causes of lymphedema include aplasia (lack of development) or hypoplasia (underdevelopment) of the lymphatic system; inflammatory diseases, such as bacterial infections; malignancies, where the lymphatics or lymph nodes can be blocked by tumor cells; surgical removal of various lymph nodes; radiation therapy; local trauma to a limb; and blockage of lymphatics by various parasites. Various system diseases can cause lymphedema, including myxedema, renal disease (such as nephrosis or nephritis), and collagen diseases.

The lymphatic system is a primary system in the body for removal of the excess fluids that produce the edema or swelling. A healthy lymphatic system is therefore necessary for preventing and reducing edema. As noted above, the body's muscle systems motivate or assist in the motivation of lymph through the body toward the lymph nodes. It is known that externally applied compressive forces—for example, as produced with a compressive wrap or bandage—can also assist the lymphatic system in reducing and/or preventing edema.

### SUMMARY OF THE INVENTION

Embodiments of the present invention provide a pressure cuff, comprising a plurality of layers and a controller. The layers comprise: an outer covering, an outer surface of which is exposed when the pressure cuff is secured around a body part of a patient; a first conductive layer; a first insulating layer separating the outer covering and the first conductive layer; an inner covering, the inner surface of which contacts the patient or the patient's clothing when the pressure cuff is secured to the patient; a second conductive layer; a second insulating layer separating the inner covering and the second conductive layer; and a first piezoelectric support layer separating the first and second conductive layers. The controller is electrically coupled to the first and second conductive layers and configured to supply a voltage to the first and second conductive layers, whereupon the first piezoelectric support layer constricts around the body part of the patient.

### BRIEF DESCRIPTION OF THE DRAWINGS

FIG. 1 illustrates an embodiment of a pressure cuff of the present invention wrapped around the arm of a patient;

FIG. 2 is a schematic cross-sectional view of a portion of the pressure cuff of FIG. 1; and

FIG. 3 is a cut-away view of the pressure cuff of FIG. 1.

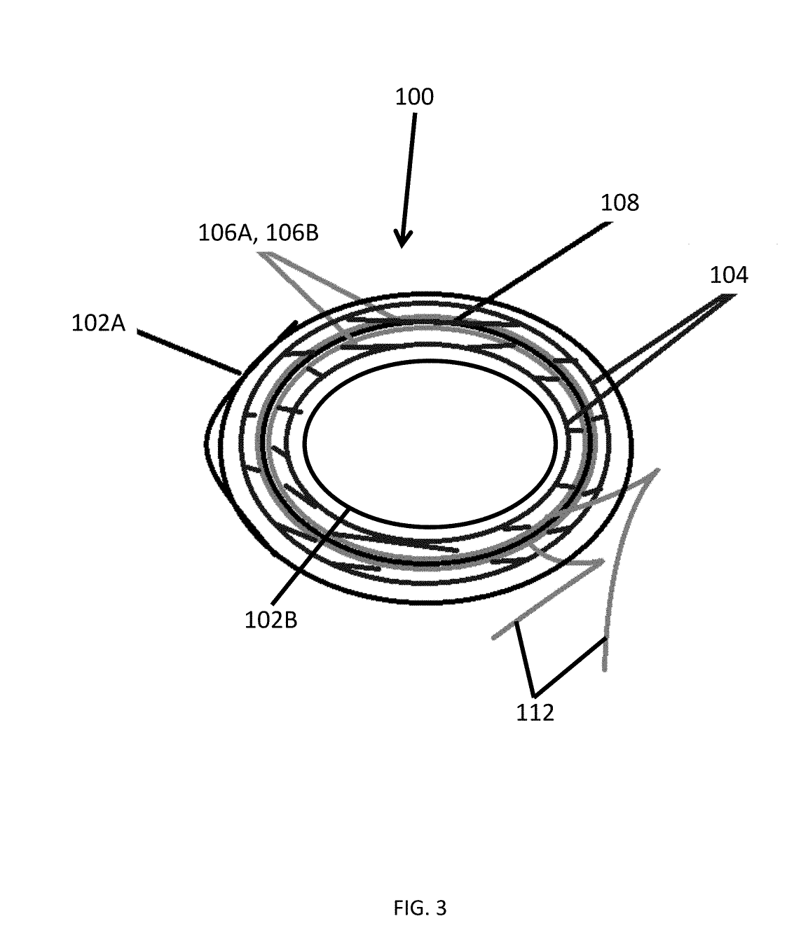

### DETAILED DESCRIPTION OF THE PREFERRED EMBODIMENT

The described features, structures, or characteristics of the invention may be combined in any suitable manner in one or more embodiments. In the following description, numerous specific details are provided to provide a thorough understanding of embodiments of the invention. One skilled in the relevant art will recognize, however, that the invention can be practiced without one or more of the specific details, or with other methods, components and so forth. In other instances, well-known structures, materials, or operations are not shown or described in detail to avoid obscuring aspects of the invention.

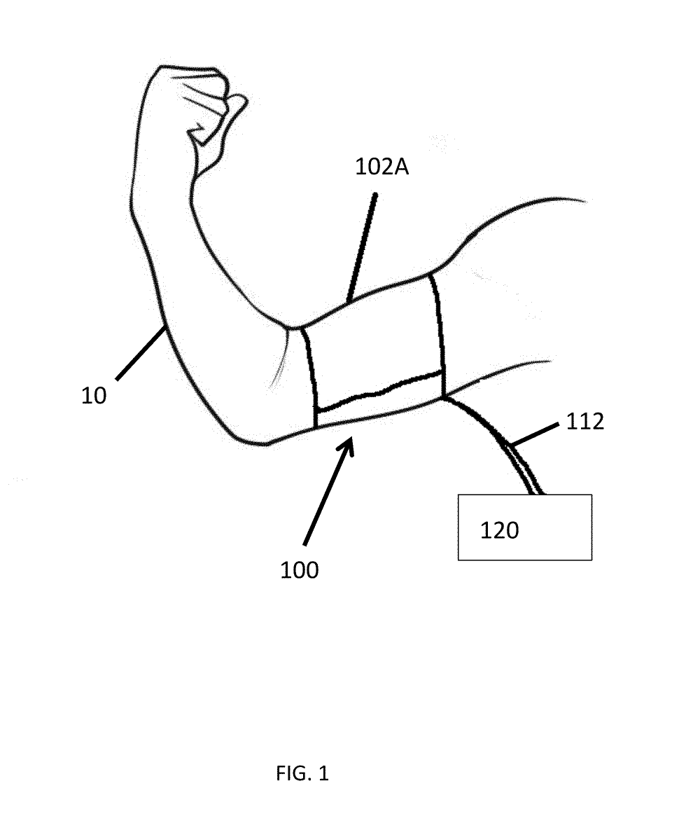

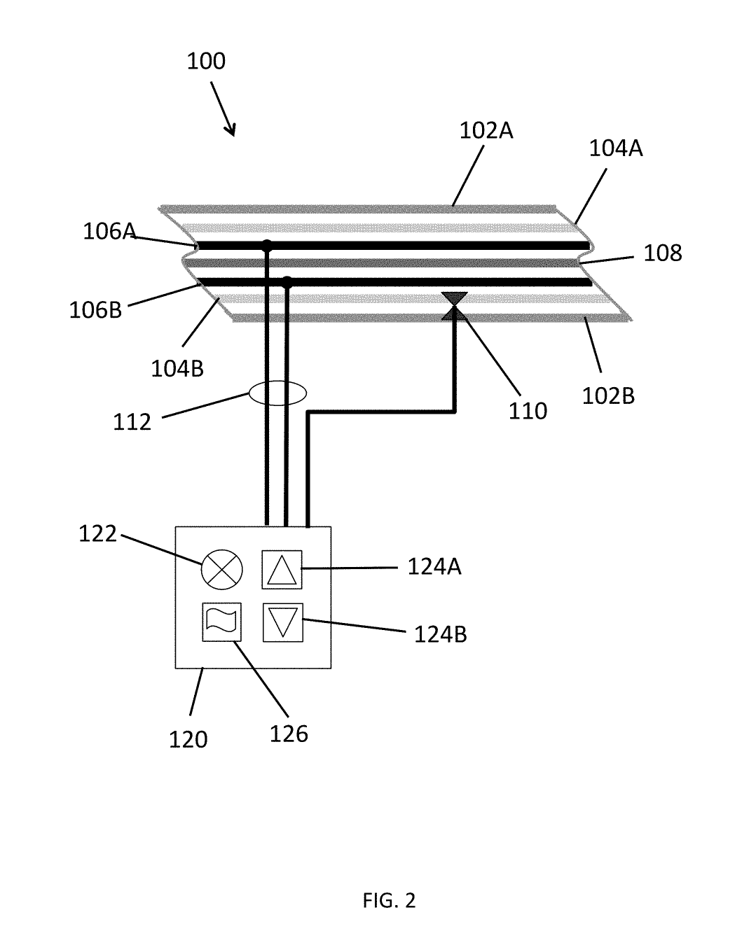

FIG. 1 illustrates an embodiment of a pressure cuff 100 of the present invention wrapped around the upper arm 10 of a patient. Although the cuff 100 is shown wrapped around the arm of the patient, it may be adapted to fit around any other limb or other part of the patient to provide pressure or support to the covered area. As illustrated in FIG. 2, and beginning from the exposed outside of the cuff 100 toward the inside, the cuff 100 includes an outer covering 102A that surrounds the outside of the cuff 100 and holds the cuff 100 in place around an area of the patient, such as with clips, a hook-and-loop material such as Velcro®, or other appropriate method. Adjacent to the inner surface of the outer covering 102A is a layer of insulating material 104A followed by a first conductor 106A surrounding the outside of one or more layers of a piezoelectric supportive material 108. Adjacent to the inside surface of the piezoelectric material 108 is a second conductor 106B followed by another layer of insulating material 104B which is covered by an inner covering 102B that, in use, is next to the patient or the patient's clothing. As used herein, the terms outer and inner are referenced relative to the patient with inner components being closer to the patient than the piezoelectric material 108 and outer components being farther from the patient than the piezoelectric material 108.

The conductors 106A, 106B are coupled by wires 112 to a controller and power supply 120. Preferably, one or more pressure sensors 110 are embedded in the cuff 100, such as in the inner insulating material 104B and is also electrically coupled to the controller 120.

The piezoelectric material 108 is preferably elastic in nature and shaped to match a particular body part, such as the arm or foot. While various piezoelectric supportive materials may be employed, the choice of material is dependent in part on the amount of pressure to be applied to the body, its commercial availability, and its cost. Piezoelectric polyvinylidene fluoride (PVDF) is one example of a material that may be used for the piezoelectric material 108 due to its excellent piezoelectric constant (allowing it to stretch more than some other materials when the same amount of voltage potential is applied), its availability, and it reasonable cost to manufacture.

The conductors 106A, 106B provide a voltage potential to the piezoelectric material 108. One material that may be used is Poly(3,4-ethylenedioxythiophene) polystyrene sulfonate (PEDOT:PSS), which is a conductive polymer that is easy to spin coat or print on another surface. PEDOT:PSS provides superior flexibility in juxtaposition with typical electrode materials, such gold, silver, or copper. The inner insulating material 104B and inner material 102B prevent the inner conductor 106B from coming into contact with the patient.

The inner material 102B may be a small diameter porous material to draw off perspiration and allow it to move away from the body, thereby cooling the patient naturally. The inner material 102B may also reduce irritation or chaffing of the patient's skin.

When a DC voltage is supplied to outer and inner conductors 106A, 106B, such as by pressing an on/off button 122 on the controller 120, a charge builds up in the conductors 106A, 106B that have a negative dipole side and a positive dipole side. The charge on each conductor 106A, 106B will either repulse or attract the dipoles of the other conductor 106B, 106A, based on the attraction of opposite charges. A negative potential on the positive dipole side of the piezoelectric material 108 causes a linear strain response in the crystal structure of the piezoelectric material 108. The linear strain response results in a constriction of the piezoelectric material 108, thereby creating pressure on the part of the patient's body around which the cuff 100 is wrapped. When the current to the cuff 100 is turned off, piezoelectric material 108 may completely relax to make donning and doffing the cuff 100 easier.

The size and number of layers of the piezoelectric material 108 may be varied to alter the amount of counter pressure exerted. Thus, for example, if the greater pressure is desired, more layers of piezoelectric material 108 may be added to increase the amount of pressure being applied.

It is preferable to apply the maximum voltage, 1,000 DC volts or 800 AC volts, to the piezoelectric material 108 in order to generate the greatest pressure on the body. However, the controller 120 may include buttons 124A, 124B or other like controls to vary the amount of pressure applied to the body by increasing or decreasing the amount of voltage applied to the conductors 106A, 106B. The controller may also include a button 126 to activate a pulsing effect of that moves along the cuff that constricts and releases pressure sequentially in adjacent annular sections of the cuff 100, pushing excess fluid towards the patient's heart in a peristaltic-like motion. Additional layers of conductors 106A, 106B and piezoelectric material 108 may be used to facilitate such a pulsing effect in the cuff 100. The pressure sensor 110 provides pressure information to the controller 120 allowing the controller 120 to automatically increase the voltage if the pressure drops below a first predetermined value and reduce the voltage if the pressure exceeds a second predetermined value, thus keeping the pressure within a desired range. The pressure sensor 110 may also allow the pressure to be displayed or the patient to be alerted if the pressure exceeds a predetermined value.

With the invention, it can be seen that the design will provide pressure and support for individuals who have medical conditions that require this. The design has an adjustable pressure control with instant feedback that will better uniform pressure control. This will provide better comfort and treatment to the user. The design can also provide a pulsing action or a peristaltic type motion if the user requires this.

The description of the present invention has been presented for purposes of illustration and description, but is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A pressure cuff, comprising:
a plurality of layers, comprising:
an outer covering, an outer surface of which is exposed when the pressure cuff is secured around a body part of a patient;
a first conductive layer;
a first insulating layer separating the outer covering and the first conductive layer;
an inner covering, the inner surface of which contacts the patient or the patient's clothing when the pressure cuff is secured to the patient;
a second conductive layer;
a second insulating layer separating the inner covering and the second conductive layer; and
a first piezoelectric support layer separating the first and second conductive layers; and
a controller electrically coupled to the first and second conductive layers and configured to supply a voltage to the first and second conductive layers, whereupon the first piezoelectric support layer constricts around the body part of the patient.

2. The pressure cuff of claim 1, further comprising a pressure sensor embedded in one of the plurality of layers and electrically coupled to the controller, the pressure sensor configure to send information to the controller about a level of pressure applied to the body part of the patient.

3. The pressure cuff of claim 2, wherein the controller is further configured to automatically adjust the voltage supplied to the first and second conductive layers in response to the pressure sensor whereby the level of pressure applied to the body part of the patient is maintained within a predetermined range.

4. The pressure cuff of claim 1, wherein the controller comprises controls to adjust the voltage supplied to the first and second conductive layers to vary the level of pressure applied to the body part of the patient.

5. The pressure cuff of claim 1, wherein the controller comprises a control to activate a pulsing effect by the piezoelectric supportive layer that constricts and releases pressure sequentially in adjacent annular sections of the pressure cuff.

6. The pressure cuff of claim 1, wherein the piezoelectric supportive layer comprises a plurality of piezoelectric supportive layers between a plurality of corresponding conductive layers.

7. The pressure cuff of claim 1, wherein the piezoelectric supportive layer comprises piezoelectric polyvinylidene fluoride (PVDF).

8. The pressure cuff of claim 1, wherein the first and second conductive layers comprise poly(3,4-ethylenedioxythiophene) polystyrene sulfonate (PEDOT:PSS).
